(19) United States
(12) Patent Application Publication
(10) Pub. No.: US 2007/0144660 A1
(43) Pub. Date: Jun. 28, 2007

(54) Breathable elastic laminates and methods of manufacturing same

(76) Inventors: Matthew John O'Sickey, Terre Haute (IN); Timothy L. Clark, Sullivan, IN (US); Andrew J. Peacock, Terre Haute (IN); James W. Cree, Chesterfield, VA (US)

Correspondence Address: SYNNESTVEDT & LECHNER, LLP, 1101 MARKET STREET, 26TH FLOOR, PHILADELPHIA, PA, 19107-2950, US

(21) Appl. No.: 10/583,221

(22) PCT Filed: Dec. 17, 2004
(86) PCT No.: PCT/US04/42538

§ 371 Date: Jun. 16, 2006

Related U.S. Application Data
(60) Provisional application No. 60/530,883, filed on Dec. 18, 2003.
(60) Provisional application No. 60/585,186, filed on Jul. 2, 2004.

(51) Int. Cl. B29C 65/00; B32B 37/00; B32B 38/00; B32B 38/04

(52) U.S. Cl. 156/229; 156/244.11; 156/253; 156/285

(57) ABSTRACT

Methods, apparatus and articles of manufacture are disclosed for providing breathable elastic laminates comprised of one or more elastic materials bonded to on or more nonelastic materials. Articles of use are also disclosed.

### CROSS-REFERENCE TO RELATED APPLICATIONS

This application claims the benefit of the filing date from U.S. Ser. No. 60/530,883, filed on Dec. 18, 2003, by Matthew J. O'Sickey, Constance S. Donnelly and James W. Cree, which disclosure is incorporated herein by reference, and,

the benefit of the filing date from U.S. Ser. No. 60/585,186, filed on Jul. 2, 2004, by James W. Cree, which disclosure is incorporated herein by reference.

### FIELD OF THE DISCLOSURE

The present disclosure is related to breathable elastic laminates and their methods of manufacture. More particularly, the present disclosure is related to breathable elastic laminates comprised of elastic and nonelastic materials.

### BACKGROUND OF THE DISCLOSURE

Breathable elastic laminates are used in the manufacture of many goods, however, providing a laminate that is both breathable and elastic may be difficult. Often, an elastomeric material is combined with a nonwoven material. However, each of the two materials generally lacks some desirable characteristics. For example, elastomeric materials generally lack characteristics that provide breathability and pleasant tactiles, and nonwoven materials generally lack characteristics that provide elasticity. A laminate with the two materials used as components may therefore lack the characteristics that each material individually lacks. Accordingly, the engineering of a laminate often attempts to overcome its components' deficiencies.

In addition to compensating for component deficiencies, other characteristics that may be desired in a breathable elastic laminate further complicate the provision of those laminates. For example, softness, controlled stretch, etc. may be desired characteristics. However, providing those characteristics to a laminate—while trying to assure breathability and elasticity in the laminate—may be difficult.

Other difficulties may arise in providing laminates for disposable uses. Disposable uses often require relatively inexpensive laminates. However, providing a relatively inexpensive laminate—while still attempting to provide desired characteristics such as breathability, elasticity, etc.—may be extremely difficult.

### BRIEF DESCRIPTION OF THE DRAWINGS

FIG. 1 shows a view of a preferred embodiment.

FIG. 2 shows a view of a preferred embodiment.

FIG. 3 shows a top view of the embodiment of FIG. 2.

FIG. 4 shows a view of a preferred embodiment.

FIG. 5 shows a partial view of a preferred embodiment.

FIG. 6 shows a view of a preferred embodiment.

FIG. 7 shows a view of a preferred embodiment.

### DETAILED DESCRIPTION OF THE PREFERRED EMBODIMENTS

The present preferred embodiments provide improved breathable elastic laminates and methods of making same. Articles of manufacture are also taught herein.

The details of one or more embodiments of the invention are set forth in the accompanying drawings and the description below. Other features, objects, and advantages of the invention will be apparent from the description and drawings, and from the claims.

An elastic or elastomeric (the words “elastic” and “elastomeric” are used interchangeably herein) layer is used that may be of any suitable material. For example, an elastic layer may comprise natural polymeric materials and synthetic polymeric materials including isoprenes, butadiene-styrene materials, styrene block copolymers (e.g., styrene/isoprene/styrene (SIS), styrene/butadiene/styrene (SBS), or styrene/ethylene-butadiene/styrene (SEBS) block copolymers) olefinic elastomers, polyetheresters, polyurethanes, etc. In certain preferred embodiments, the elastomeric materials can comprise high performance elastomeric material such as Kraton® elastomeric resins from the Shell Chemical Co., which are elastomeric block copolymers.

The form of an elastic layer may be any suitable type, such as, for example, elastic strands, elastic nonwoven, elastic film, elastic adhesive, elastic tacky polymeric web, elastic scrim, etc. In certain preferred embodiments, a skinless elastic is used. That is, an elastic is provided without a less elastic skin layer. It may also be desired, in various embodiments to provide a slit elastic, e.g., for increased breathability, etc.

Laminated to an elastic layer are one or more nonelastic materials. These materials comprise a nonelastic layer in preferred embodiments and are of any suitable material. They are called nonelastic herein to distinguish them from the elastic layer, however, it should be understood that the nonelastic materials used herein may possess elastic qualities.

Examples of materials used include thermoplastic film material, such as polyethylene, polypropylene, ethylene vinyl acetate and other such polymeric materials; fibrous material (which can comprise a fibrous web, woven and/or non-woven materials, including polyesters, polyolefins, acrylics, rayons, cottons and other cellulose materials, thermoplastic elastomers, and blends of the same, etc.) In preferred embodiments, the nonelastic layers are comprised of a suitable nonwoven layer, such as, for example, polyethylene, polypropylene, etc. The form of a nonelastic layer may be any suitable type, such as, for example, spunbonded, carded, thermobonded, melt blown nonwovens, loose fibers, or a variety of woven materials which comprise different basis weights, fiber compositions, fibers of different geometries, lengths, diameters and surface finishes. Nonelastic materials can also comprise bi-component fibers or various fiber morphologies and geometries (e.g. having an inner core of one material and an outer core of a second material).

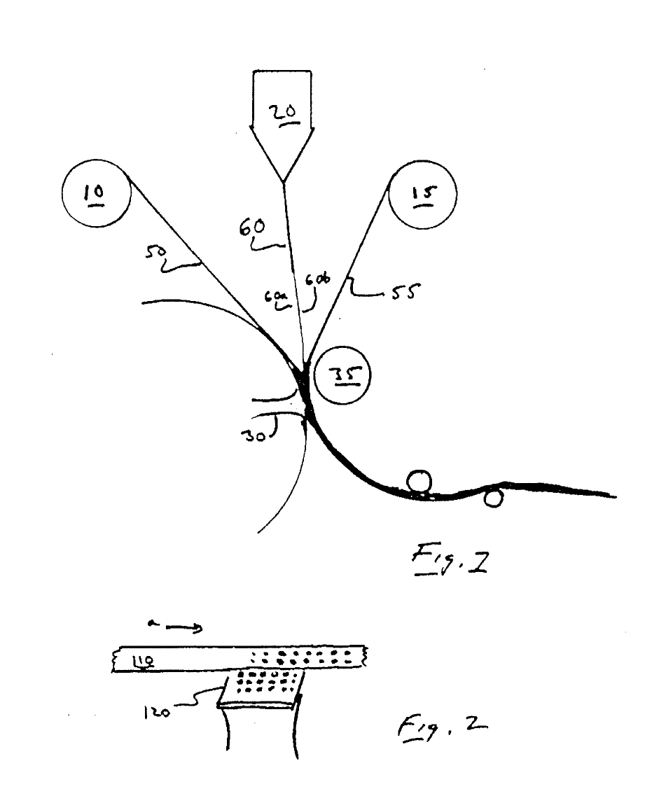

Turning now to FIG. 1, a view of a preferred embodiment is shown. This embodiment provides a breathable elastic trilaminate. First nonelastic source 10 is for providing a first nonelastic material 50. In this embodiment a nonelastic source is shown that comprises a roll of material, however, as was described above any suitable nonelastic material may be used. Therefore, in various embodiments, nonelastic source 10 may be any suitable source according to the material provided. For example, the source may be a pre-formed roll of material, or it may be a piece of equipment (e.g., an extruder) for forming the material in situ.

Returning now to the embodiment of FIG. 1, second nonelastic source 15 is for providing a second nonelastic material 55. In this embodiment a nonelastic source is shown that comprises a roll of material, however, as was described above, any suitable nonelastic material source may be used, such as pre-formed rolls of material, extrusion sources, carding machines, and the like.

It should be noted, that the first nonelastic material and second nonelastic material may be either the same or different materials. Additionally, the materials may vary in physical dimension as well. So for example, a thinner width for a first nonelastic material may be desired, a broader width, etc. Also other characteristics, such as thickness of the laminate, basis weight of the layers, etc. may all be modified as desired.

FIG. 1 also shows elastic source 20, for providing elastic material 60. In this embodiment an elastic source is shown that comprises a slot die or blown die for extruding molten or semimolten elastic material, however, in various embodiments, any suitable source may be used. For example, elastic material used in various embodiments may be a coextruded multiple layer structure in which one or more of the layers could be elastic. In yet other embodiments, a skinless elastic is used. In those embodiments, therefore, an elastic layer is extruded without (a usually less elastic) skin.

FIG. 1 also shows pressure differential source 30. Pressure differential source 30 is for providing a pressure differential to a laminate in order to rupture, at least partially, the laminate, as is further described below. The ruptures in the laminate, in preferred embodiments, are three dimensional apertures. The apertures are provided in order to allow pass-through of air or other fluids as desired, thus providing breathability to the laminate.

Pressure differential source 30 may be any suitable source. In the preferred embodiments, pressure differential source 30 comprises a vacuum, which results in a greater pressure on one side of the laminate. The vacuum created pressure differential will rupture the laminate and thus provide apertures. An aperture definition device (not shown in FIG. 1) may be used as well. In preferred embodiments, an aperture definition device for providing direction to shape the apertures caused by pressure differential source 30, as will be described further below.

Pressure source 35 is for providing pressure to the materials, as will be further described below. A nip roll is used in the preferred embodiments, although any suitable source may be used as a pressure source. Additionally, some embodiments may dispense with a pressure source, or use a pressure differential source as a pressure source as well. Moreover, pressure source 35 is shown here as being present at a certain area; before the area where pressure differential source applies a pressure to the materials. However, it should be noted that a pressure source may also or alternatively be located at other areas, for example, where a pressure differential source applies a pressure differential; below the pressure differential area; etc.

First nonelastic material 50 is brought into contact with elastic material 60. The convention herein is to describe the side on which the first nonelastic is provided as the male side of the elastic. Second nonelastic material 55 is also brought into contact with elastic material 60, which is described herein as the female side of the elastic. The molten or semimolten phase of elastic material 60 in this embodiment may provide a degree of bonding on both male and female sides with first nonelastic material 50 and second nonelastic material 55, e.g., material 50 to side 60a and material 55 to side 60b. At the point of contact with pressure source 35, the materials may undergo bonding as well, as the pressure imposed by pressure source 35 assists in adhering first nonelastic material 50 and second nonelastic material 55 to their respective sides.

It should be noted that, in those embodiments where a skinless elastic is used, processing is simplified, as there is no need to provide a coextrusion device, for example.

The now bonded materials, referred to as a laminate hereinafter, then are provided to pressure differential source 30. The first nonelastic material (50), on the male side of the elastic, is interposed between the pressure differential source 30 and the elastic material 60. Both the first nonelastic material and the elastic are interposed between the pressure differential source 30 and the second elastic material 55. Here pressure differential source 30 supplies a differential that is for providing ruptures to the laminate. The rupture is in the form of three dimensional apertures. These three dimensional apertures are especially preferred where fluids are encountered in use of a laminate and/or article. Embodiments may however, also use other suitable aperturing as desired. For example, embodiments may use a slitting or other process instead of or in addition to a pressure differential source.

Turning briefly to FIG. 2, a view of a rupture process of a preferred embodiment is seen. Laminate 110 passes over aperture definition device 120. In this embodiment, aperture definition device 120 comprises a screen with 20 apertures per linear inch in a square pattern, referred to herein as 20 square. Other suitable aperture definition devices may be used in other embodiments. For example, aperture definition devices may provide various percentages of open areas, aperture sizes, geometries, etc.

The preferred embodiments may also vary patterns while maintaining generally consistent fluid pass-through volume in the laminate. For example, many smaller apertures may be desired in a laminate, while fewer larger apertures may be desired in another area of the same laminates. The use of varying patterns may not affect pass-through volume: e.g., many smaller apertures in a surface area may equate to a similar pass-through volume as fewer larger apertures in the same surface area.

As the laminate passes over aperture definition device 120, in the direction shown as a, vacuum source 130 supplies a vacuum to the laminate. The strength of the vacuum is sufficient to stretch areas of the laminate by pulling those areas into the apertures in aperture definition device, where the areas of the laminate in the apertures will eventually be stressed beyond their stretch limit and rupture. The ruptures will occur along the pattern supplied by aperture definition device 120.

It should be noted that in certain embodiments, it may be desired to impose a pressure differential on the elastic only, prior to lamination. Thus, a pressure differential source may rupture the elastic prior to lamination.

A top view of the process of FIG. 2 is seen at FIG. 3, with the resulting pattern shown at 135. For various production reasons, of course, (e.g., resistance by a first nonelastic material to a pressure differential, etc.) patterns mirroring the aperture device pattern may not be present on the laminate, as in pattern 135a. Aperture definition devices and pressure differential sources may need to be calibrated according to the nature of the materials and their alignment. A feed back process may be desirable in some embodiments in order to accomplish that calibration.

Patterning, variable apertures, and other desired attributes may also be provided through the use of more than one aperture definition device and/or the use of suitable aperture definition devices, e.g., pin punching. For example, a device in one area may provide one pattern of apertures, and a device in another area provide another desired pattern.

An aperture definition device may provide modification of the pressure differential imposed by the pressure differential source. For example, if a vacuum type pressure differential source is used, an aperture definition device comprised of venturis leading from the source to the laminate will modify the vacuum provided by the source.

Any aperture definition device may be subject to clogging or other interference as a result of drawing the elastic or nonelastic material into the device. According, it may be desired to provide cleaning type devices. Any suitable cleaning type devices may be used, such as slotted screens, bands across screens, etc. Additionally, aperture parameters such as the angles of any apertures on the aperture definition device may be changed, etc. Other parameters that also may be desirably changed include temperature, pressure differential strength, time of pressure differential application, etc.

Returning now to the embodiment of FIG. 1, as was described above, bonding of first nonelastic material 50 and second nonelastic material 55 may occur in a number of ways. Some bonding occurs through contact with the molten or semimolten phase of elastic material 60 Bonding may also occur through imposition of pressure by a pressure source, as was described above with regard to the embodiment of FIG. 1. Bonding may occur through pressure imposed by a pressure differential. For example, in certain embodiments a vacuum will supply pressure to the materials and thus draw them together, either in addition to a pressure source or instead of a pressure source.

Any such process may be modified as desired in this or other embodiments. So, for example, by manipulating the phase of an elastic material, e.g., keeping the material heated as it contacts a nonelastic in order to maintain a molten phase, a more complete degree of bonding may be present between the elastic layer and the nonelastic material. As another example, chilling the elastic to a tacky phase may provide a less inclusive degree of bonding.

Bonding may also be directed as desired in various embodiments. For example, alternating elastic material phases during a production process may provide selectively bonded regions. A relatively molten elastic material phase might be followed by a relatively solid phase, generally providing sites of increased and decreased bond. As another example, a variable pressure may be imposed upon the materials resulting in greater and lesser bonded areas.

As another example, a pressure differential source and/or pressure source might be configured to supply variable bonding sites of the laminate. As yet another example, variables such as time of bonding, temperature at which bonding occurs, pressure applied to the materials during bonding all may be varied as desired. Variable bonding sites may also impose air channels, such as, for example, between a nonelastic and elastic, providing further capability for tailorable breathability, loft, and tactile properties to the laminate.

Embodiments may also provide a laminate with different numbers of layers. For example, a two layer laminate may be provided having a nonelastic and elastic layer. In two layer embodiments, a nonelastic may be provided on the female or male side of the elastic. As another example, a three layer laminate may be provided having two elastic layers and a nonelastic layer, or, alternatively, two nonelastic layers and an elastic layer; a four layer laminate may be provided having two nonelastic and two elastic layers, or, alternatively, three nonelastic and one elastic layers; etc.

Other methods of lamination may be used as well. For example, nonelastic materials may be bound, in whole or part, using any suitable method, such as hot pin aperturing, adhesive bonding, thermal bonding, ultrasonic bonding, or any other suitable method.

Turning to FIG. 4, a view is seen of a preferred embodiment that provides a bilaminate with an elastic layer and nonelastic layer. Elastic tacky polymeric web 410 is extruded directly onto a nonelastic material, here a preslit nonwoven material 420. The nonelastic bonds on the female side of the elastic, resulting in the laminate shown generally at 430. Machine direction is shown in the direction of arrow b. It should be noted that various temperature, time, vacuum and other parameters will vary in various embodiments depending upon the type of materials being used, the degree of bonding desired, the particular process or equipment being used, etc.

As was described above, the nonelastic materials used in various embodiments may be any suitable type and form. Moreover, the nonelastic may be modified as desired as well, e.g., thermally, chemically, mechanically, etc. For example, in the laminate of FIG. 4, the nonelastic material was slit before lamination, as shown generally at 425. By providing slits or incisions to the nonwoven material, the mechanical characteristics of extensibility are imparted to the material. Of course, any type of incisions, number of incisions patterns, etc. may be used as desired.

For example, FIG. 5 shows an example of an incision device. Roll 502 includes a plurality of blade regions 506 that extend substantially parallel to a longitudinal axis running through the center of the cylindrical roll 502. B lade regions 506 include a plurality of blades 507. Roll 504 includes a plurality of blades 510 which mesh with tension regions 507 on roll 502. As a nonwoven material is passed between intermeshing rolls 502 and 504, the blades 507 will incise regions of the nonwoven material while leaving others untouched.

Alternatively, roll 504 may consist of a soft rubber, steel or other material. As the material is passed between bladed roll 502 and roll 504 the material will be incised as desired.

The characteristics as imparted through apertures or incisions may be varied as desired. So for example, incisions of various preferred embodiments may be in various numbers, patterns, locations and/or orientations, in order to provide predetermined characteristics. For example, predetermined stretch characteristics may be provided through particular numbers, patterns, locations and/or orientations of slits and/or other incisions. In other embodiments, the types of incisions themselves may be varied, for example, various shapes may be used as desired, (for example, thin rectangles, S-shaped curves, arcs, V-shapes, etc.) so long as desired predetermined parameters are imparted. Types may be mixed, as well as numbers, patterns, locations aid/or orientations. Of course, incised regions may be interposed with nonincised regions as well, so as to provide zones or regions of extensibility to the laminate.

The modification of incisions (whether slits as in especially preferred embodiments or otherwise) and subsequent modification of predetermined parameters such as stretch characteristics, may be utilized for subsequent articles to be constructed from the laminate. So for example, regions of varying stretch and/or other characteristics, (e.g., breathability) may be provided within a laminate for diaper product construction. Such a laminate might have zones of greater and lesser stretch, so that a part of the laminate to be used in constructing a leg surround area would have greater stretch, while another part of the laminate to be used for covering a baby's buttocks would have lesser stretch. Similarly if the laminate is to be used in the diaper tabs for sealing, greater stretch would be imparted to the laminate, while lesser stretch might be desirable in a laminate used across the crotch span.

In various preferred embodiments, the incisions are slits. Preslit material may be used as well. A nonwoven material with slits used in an especially preferred embodiment is produced by Lark Industries of South Korea, which has low pilling and fuzz properties. So, for example, in some preferred embodiments, elastic tacky polymeric web is extruded directly onto a preslit nonwoven material.

Various embodiments may provide extensibility of the laminate in the cross direction, machine direction, angularly with respect to either the machine or cross direction and/or a combination thereof, and thus biaxially extensible embodiments may be provided.

FIG. 6 shows another embodiment. Nonwoven web 631 has a plurality of incisions (635, 636, 637 and 638, for example.) An elastomeric member (not shown) may then be laminated to nonwoven web 631. Machine direction is shown in the direction of arrow c.

Of course, in other embodiments, suitable lamination methods known in the art may be used, such as hot pin aperturing, adhesive bonding, thermal bonding, sonic bonding, or any other suitable method.

The laminates may be any number of layers as desired. As was described above, it is possible to bond to either side of the elastic material, so a two layer laminate or bilaminate may be desired. So, for example, FIG. 4 above shows a process for forming a two layer embodiment. Additional layers, if not laminated according to a method similarly to that described above, may be bonded to the laminate through any suitable method as known in the art: hot pin aperturing, adhesive bonding, thermal bonding, sonic bonding, or any other suitable method.

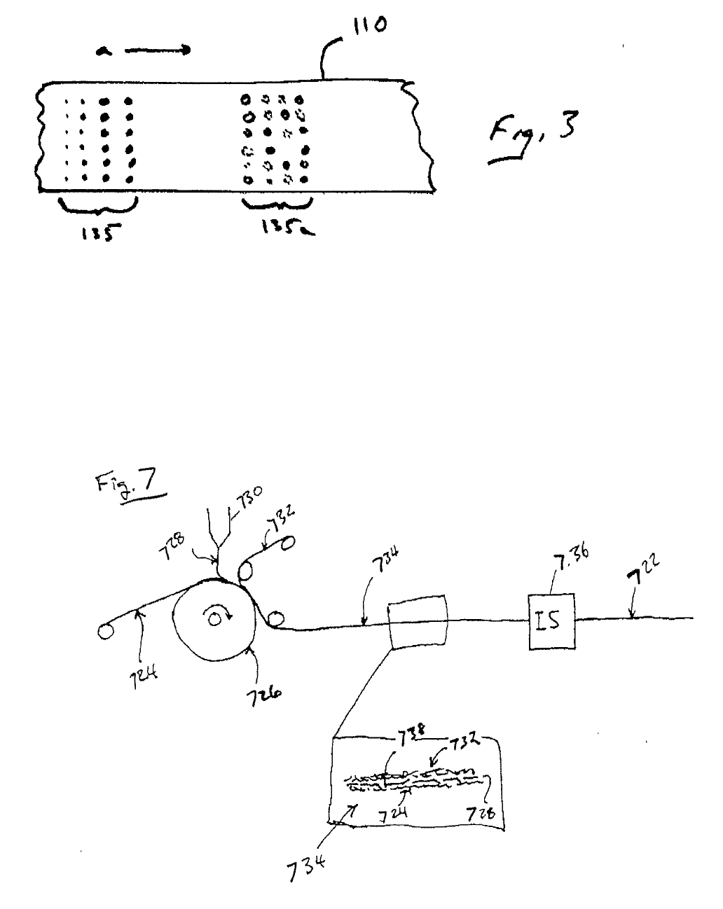

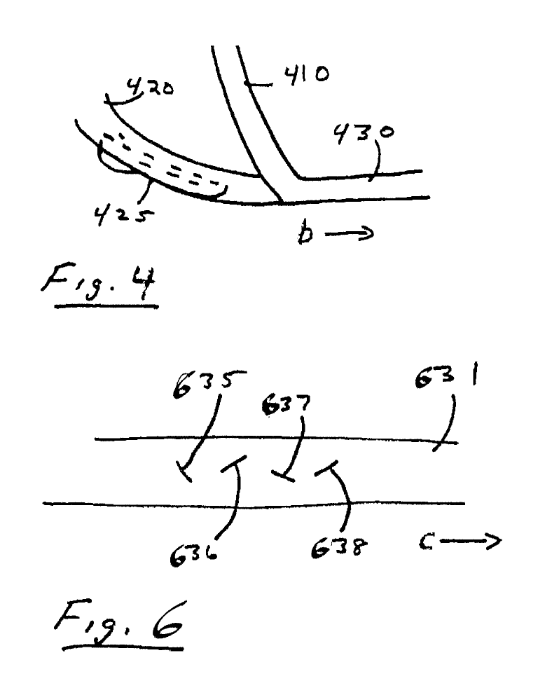

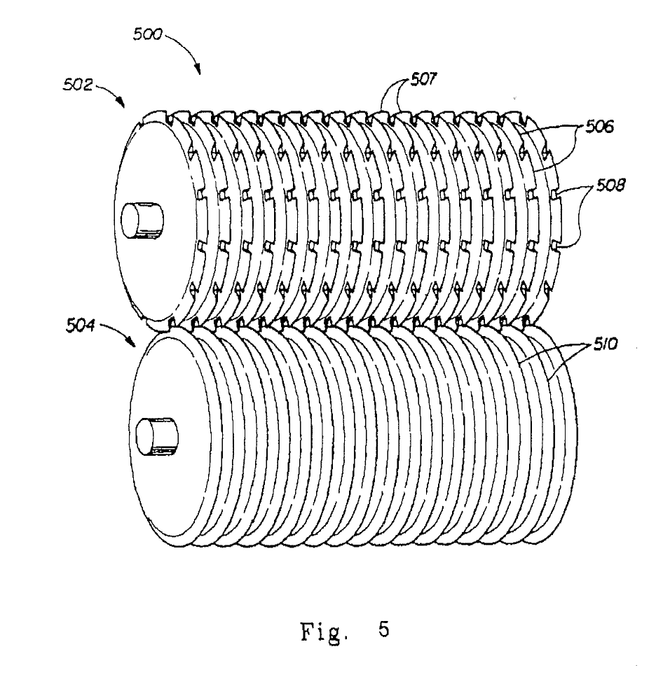

Another preferred embodiment of a trilaminate is shown in FIG. 7. Elastic laminate 722 comprises three layers: a first nonwoven layer 724, an elastic film layer 728, and a second nonwoven layer 732. The elastic laminate 722 is formed by introducing the first nonwoven layer 724 to a screen 726. The first nonwoven layer 724 is positioned on screen 726 while elastic film material 728 is extruded from die 730 onto the first nonwoven layer 724. Second nonwoven 732 is introduced opposite the first nonwoven 724 and bonded to the elastic film material 728. The second nonwoven 732 may be introduced while the elastic film material 728 is still malleable and thereby thermo bonded to the elastic film material 728. Alternatively, the second nonwoven 732 may be bonded to the elastic film material through hot pin aperturing, pressure differential bonding, adhesive bonding, thermal bonding, ultrasonic bonding, or any other suitable method. Once the second nonwoven 732 is bonded to the elastic film material 728, which is already bonded to first nonwoven 724, laminate 734 is formed. In one example, a 16 gsm (grams per square meter) spun bond polypropylene nonwoven web sold by BBA Nonwovens as BBA 699D is used as second nonwoven 732 and a 24 gsm carded polypropylene nonwoven web sold by BBA Nonwovens as BBN 333D is used as first nonwoven 724.

Further treatment of the laminate may be desired in some preferred embodiments. For example, a laminate may be activated to provided desired stretch. Activation could occur through any suitable means, e.g., ring rolling, intermeshing gears, uniaxial or biaxial orientation, etc. Activation may increase laminate elasticity through rupturing or elongating the fibers of the nonelastic material or materials.

Usually, laminate stretching is directionally specific, so that, for example, stretching may be in the machine direction (MD), transverse direction (TD) (also known as the cross direction (CD)), diagonally, a combination of directions, etc. Further, activation may occur along the entire laminate, or only in pre-determined areas of the laminate.

The characteristics as imparted through activation may be varied as desired. So for example, activation in various preferred embodiments may be in various patterns, locations and/or orientations, in order to provide predetermined characteristics. For example, predetermined stretch characteristics may be provided through particular patterns, locations and/or orientations of stretched laminate. In other embodiments, the degree of activation may be varied, for example, a weakly activated area may be used to give a laminate a weak elasticity, followed by a strongly activated area to give a laminate a strong area of elasticity. Of course, activated regions may be interposed with nonactivated regions as well, so as to provide zones or regions of extensibility to the laminate.

Activation and subsequent modification of predetermined parameters such as stretch characteristics may be within a web intended for manufacturing an article. So for example, regions of varying stretch and/or other characteristics (e.g. breathability) may be provided within a laminate for diaper product construction. Such a laminate might have zones of greater and lesser stretch, so that a part of the laminate to be used in constructing a leg surround area would have greater stretch, while another part of the laminate to be used for covering a baby's buttocks would have lesser stretch. Similarly if the laminate is to be used in the diaper tabs, greater stretch would be imparted to the laminate, while lesser stretch might be desirable in a laminate used across the crotch span.

Of course, apertured nonelastic materials may be used in combination with stretched laminates as well.

Laminates may have various characteristics as a result of their construction. For example, various elastic and nonelastic materials will provide various characteristics of bond, softness, elastic, breathability, etc. In addition to the characteristics provided by the materials used, various processes of preferred embodiments may modify the laminate characteristics of bond, softness, elasticity, and breathability.

Those processes used to modify laminate characteristics are: modifying the phase of the elastic material prior to bonding; modifying the pressure differential applied by a pressure differential source; modifying pressure imposed by a pressure source; modifying apertures in a nonelastic material; modifying apertures provided in an aperture definition device; various secondary treatments of the laminate and/or components of the laminate (e.g. plasma treatment) and, modifying stretching of a laminate following lamination.

For example, a bond may be modified through modification of various parameters of a process of preferred embodiments, e.g., modifying the phase of the elastic material prior to bonding will modify bond strength; modifying pressure imposed by a pressure source will modify bond strength, modifying a pressure differential imposed by a pressure differential source will modify bond strength, line speed, plasma treating of the elastic prior to adhesive bonding, type of materials used, etc. will also modify bond strength.

As another example, softness of a laminate may be modified through modification of various parameters of a process of preferred embodiments, e.g., modifying pressure imposed by a pressure source will modify the embedding of a nonelastic within an elastic, and thus modify the feel of the laminate; modifying a pressure differential imposed by a pressure differential source will modify the embedding of a nonelastic within an elastic, and thus modify the feel of the laminate; etc.

As another example, elasticity of a laminate may be modified through modification of various parameters of a process of preferred embodiments, e.g., modifying apertures provided to a nonelastic will modify the elasticity, modifying laminate stretching will modify the elasticity; etc.

As another example, breathability of a laminate may be modified through modification of various parameters of a process of preferred embodiments, e.g., controlling temperature and phase of the elastic material, modifying the apertures provided in an appropriate aperture definition device; modifying a pressure differential imposed by a pressure differential source will modify the nature of the apertures produced, etc.

In various preferred embodiments, the processes described above and/or combinations of the processes described above may be used to provide laminates having desired characteristics of bond strength, softness, elasticity, and breathability.

The construction of the laminates may also be modified so as to provide desired characteristics. Thus, it should be noted that a laminate may be tailored for use in a final application with desired characteristics. For example, a laminate may be formed so as to provide certain characteristics in areas of the laminate. Those may include sections or areas of the laminate. As example of this sectional tailoring was described above with regard to selective aperturing of nonelastic material areas. Another example is providing a laminate with differing characteristics tailored on either side of the laminate. For example, a laminate may be constructed with softer and less soft sides. A use of such a laminate may be in garments, with the softer side positioned adjacent the wearer's skin and less soft side facing out.

Various embodiments may be used, in whole or part, in various types of articles, such as, for example, absorbent articles, including adult, child or infant incontinence products (diapers, briefs, etc.,) female hygiene products (e.g., female menstrual products, sanitary napkins, pantiliners, etc.,) wraps, including sterile and nonsterile (e.g. bandages with and without absorbent sections,) as well as other disposable and/or multiple use products; e.g., articles proximate to a human or animal body, such as (e.g., garments, apparel, including undergarments, under- and outer-wear, for example, undershirts, bras, briefs, panties, etc., bathing suits, coveralls, socks, head coverings and bands, hats, mitten and glove liners, medical clothing, etc.;) bed sheets; medical drapes; packaging materials; protective covers; household; office; medical or construction materials; wrapping materials; etc. therapeutic devices and wraps.

A laminate may also modified in any suitable fashion, for example, a laminate may be sewn, bonded, printed, cut, shaped, glued, fluted, sterilized, etc.

Although the present invention has been described with respect to various specific embodiments, various modifications will be apparent from the present disclosure and are intended to be within the scope of the following claims.

1. A method for forming a laminate comprising:
contacting a nonelastic material with an elastic material;
introducing the combination of said nonelastic material and said elastic material to a pressure differential source in either a first way or a second way, in said first way, said nonelastic material is interposed between said pressure differential source and said elastic material, in said second way, said elastic material is interposed between said pressure differential source and said nonelastic material;
applying a pressure differential via said pressure differential source to form an apertured laminate.

2. A method for forming a laminate as in claim 1 further comprising:
introducing a third nonwoven material to said first or said second nonwoven material.

3. A method for forming a laminate as in claim 1 wherein said elastic material is skinless.

4. A method for forming a laminate as in claim 1 wherein said nonelastic material is apertured.

5. A method for forming a laminate as in claim 1 further comprising:
interposing an aperture definition device between said pressure differential source and said nonelastic material.

6. A method for forming a laminate as in claim 1 further comprising:
contacting a second nonelastic material with said elastic material;
introducing the combination of said first nonelastic material, said elastic material and said second nonelastic material to said pressure differential source in said second way.

7. A method for forming a laminate as in claim 6 further comprising:—
introducing said combination to a pressure source.

8-15. (canceled)

16. A method for forming a laminate as in claim 1, further comprising:
modifying a laminate characteristic of said laminate by at least one of: modifying the phase of the elastic material prior to bonding; modifying a pressure differential applied by a pressure differential source; modifying pressure imposed by a pressure source; modifying apertures in a nonelastic material; modifying apertures provided in a aperture definition device; or modifying stretching of a laminate following lamination.

17. A method for modifying a laminate as in claim 16 wherein said laminate characteristic is selected from the group consisting of bond, softness, elasticity and breathability.

18. A method for forming a laminate comprising:—
introducing a first nonwoven layer to a vacuum forming screen;—
extruding a thermoplastic elastomeric film material onto the first nonwoven layer opposite the screen;
applying a vacuum on the screen opposite the first nonwoven layer to pull the thermoplastic elastomeric material against the first nonwoven bonding the nonwoven to the elastomeric material and creating irregular apertures in the elastomeric material;
bonding a second nonwoven layer to the elastomeric material opposite the first nonwoven layer to form a three layer laminate; and incrementally stretching the laminate to form an elastomeric laminate.

19. An undergarment comprised primarily of the laminate formed by claim 18.

20. An absorbent article comprising:—a breathable elastic laminate comprising a low fuzz apertured nonwoven material with at least one slit; and an elastomeric member wherein said elastomeric member is laminated to said low fuzz apertured nonwoven material.

21-27. (canceled)

28. An elastic laminate comprised of:—an elastomeric film material with apertures;—a first nonwoven layer bonded to the elastomeric film material; and—a second nonwoven layer bonded to the elastomeric film material opposite the first nonwoven layer, fibers extending outwardly from both the first nonwoven layer and the second nonwoven layer.

29. An undergarment comprised primarily of the laminate of claim 28.

30-39. (canceled)

40. A composite material as in claim 28 further comprising a plurality of incisions or slits configured to impart stretch characteristics to said composite material.

41-74. (canceled)

75. A product comprising the absorbent article of claim 20, said product selected from the group consisting of: a bandage, an infant incontinence product, child incontinence product, an adult incontinence product, an incontinence product, a sanitary napkin, and a female menstrual product.
